(19) United States
(12) Patent Application Publication
(10) Pub. No.: US 2005/0267389 A1
(43) Pub. Date: Dec. 1, 2005

(54) Applicator-scrubber

(76) Inventor: Eddy Antoine, Trumbull, CT (US)

Correspondence Address: THEODORE JAY;SUITE 600, 16 NORTH CHATSCOORTH AVE, LARCHMONT, NY, 10538, US

(21) Appl. No.: 10/856,504

(22) Filed: May 28, 2004

(51) Int. Cl. A61H 7/00

(52) U.S. Cl. 601/137; 601/135

(57) ABSTRACT

A thin vertically elongated plastic member in horizontal cross section defines an arc of a circle. The member has opposed inner and outer surfaces. A flexible thin rubber like coating is secured to the outer surface of the member. The coating has an exposed surface conforming to the outer surface of the member and is provided with plurality of elements which are curved to conform to the curvature of the exposed coating surface, The elements are vertically spaced apart.

### BACKGROUND OF THE INVENTION

It is often necessary to use hand held devices to apply soap to the skin of a human subject and/or scrub the previously applied soap on the skin and clean it. The present invention is directed toward a novel device of this type that can be manufactured inexpensively and easily used.

### SUMMARY OF THE INVENTION

In accordance with the principles of this invention, a hand held device is provided for applying soap to the skin of a human subject or/or scrubbing the previously applied soap on the skin to clean it.

The device employs a thin vertically elongated plastic member which in horizontal cross section defines an arc of a circle. The arcs at the top and bottom of the member are longer than the arcs of uniform length between the ends. The member has opposed inner and outer surfaces. The inner surface is disposed adjacent the hand of a user when the device is in use. The hand then engages the opposite vertical edges of the member.

The device also employs a flexible thin rubber like coating secured to the outer surface of said member. This coating has an exposed surface conforming to said outer surface and is provided with plurality of elements which are curved to conform to the curvature of the exposed coating surface. The elements are vertically spaced apart.

These elements have pointed ends which extend outward from the coating surface

The exposed coating surface has a narrow vertical central section and the elements are arranged into two like groups disposed on opposite sides of the section and not engaging it. Each element in each group has an end adjacent the section which extends slightly downward.

The device is held in use with the elements engaging the skin of the human subject.

### BRIEF DESCRIPTION OF THE DRAWINGS

FIG. 1 is a front perspective view of a preferred embodiment of the invention.

FIG. 2 is a horizontal cross section view thereof.

FIG. 3 is a front view thereof.

FIG. 4 is a detail view taken along line 4-4 in FIG. 3.

### DETAILED DESCRIPTION OF PREFERRED EMBODIMENT

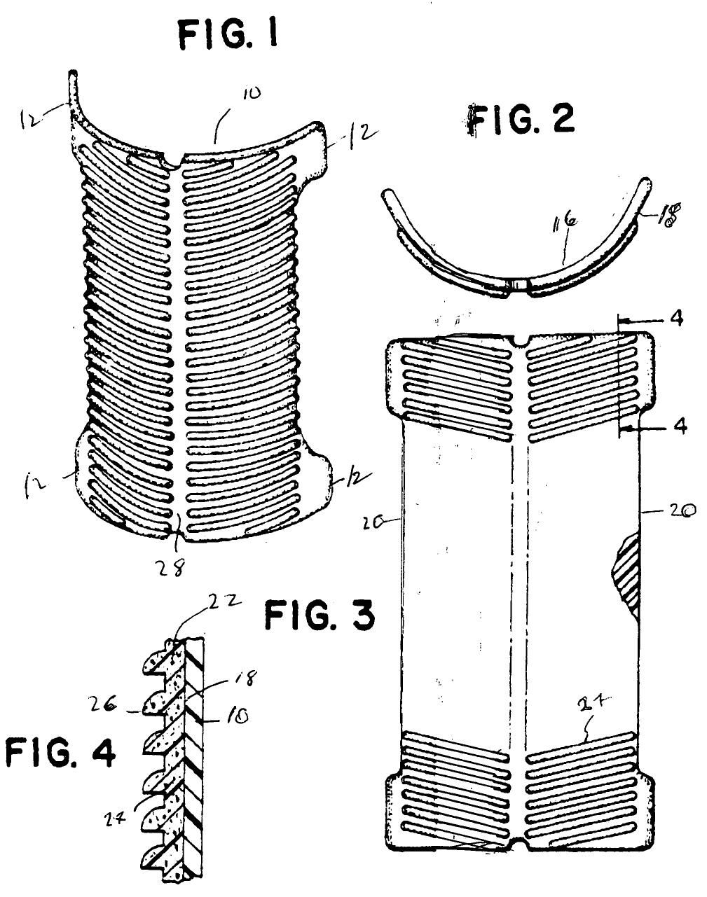

Referring now to FIGS. 1-4, there is illustrated a hand held device for applying soap to the skin of a human subject or/or scrubbing the previously applied soap on the skin.

This device employs a thin vertically elongated plastic member 10 which in horizontal cross section defines an arc of a circle. The arcs at the top and bottom of the member are longer then the arcs of uniform length between the ends. The opposite ends of the longer arcs shown at 12 provide guidance for the hand of the user. This member has opposed inner and outer surfaces 16 and 18. The inner surface 16 is disposed adjacent the hand of a user when the device is in use, the hand engaging the opposite vertical edges 20 of the member.

A flexible thin rubber like coating 22 is secured to the outer surface 18 of said member, the coating having an exposed surface conforming to outer surface 1 8and provided with plurality of elements 24 which are curved to conform to the curvature of the exposed coating surface. The elements are vertically spaced apart and have pointed ends 26 which extend outward from the coating surface. The exposed coating surface has a narrow vertical central section 28 and the elements are arranged into two like groups disposed on opposite sides of the section and not engaging it. Each element in each group has an end adjacent the section which extends slightly downward.

The coating is glued to the outer surface of the member.

While the invention has been described with particular reference to the detailed description and drawing, the protection solicited is to be limited by the claims which follow.

1. A hand held device for applying soap to the skin of a human subject or/or scrubbing the previously applied soap on the skin, said device comprising:
a thin vertically elongated plastic member which in horizontal cross section defines an arc of a circle, the arcs of uniform length at the bottom and top of the member are longer then the arcs of uniform length intermediate the top and bottom of the member, said member having opposed inner and outer surfaces, the inner surface disposed adjacent the hand of a user when the device is in use, the hand engaging the opposite vertical edges of the member; and
a flexible thin rubber like coating secured to the outer surface of said member, said coating having an exposed surface conforming to said outer surface and provided with plurality of elements which are curved to conform to the curvature of the exposed coating surface, said elements being vertically spaced apart.

2. The device of claim 1 wherein said elements have pointed ends which extend outward from the coating surface.

3. The device of claim 2 wherein said exposed coating surface has a narrow vertical central section and the elements are arranged into two like groups disposed on opposite sides of the section and not engaging it.

4. The device of claim 3 wherein each element in each group has an end adjacent the section which extends slightly downward.

5. The device of claim 4 wherein said coating is glued to the outer surface of said member.

6. A hand held device for applying soap to the skin of a human subject or/or scrubbing the previously applied soap on the skin, said device comprising:
a thin vertically elongated plastic member which in horizontal cross section defines an arc of a circle, said member having opposed inner and outer surfaces, the inner surface disposed adjacent the hand of a user when the device is in use, the hand engaging the opposite vertical edges of the member; and
a flexible thin rubber like coating secured to the outer surface of said member, said coating having an exposed surface conforming to said outer surface and provided with plurality of elements which are curved to conform to the curvature of the exposed coating surface, said elements being vertically spaced apart, said exposed coating surface having a narrow vertical central section and the elements being arranged into two like groups disposed on opposite sides of the section and not engaging it.
